(19) United States
(12) Patent Application Publication
(10) Pub. No.: US 2005/0163581 A1
(43) Pub. Date: Jul. 28, 2005

(54) Method and device for securing stacked articles

(76) Inventors: Bernd Schnoor, Friedberg (DE); John Wentzel, Koln (DE)

Correspondence Address: MCGLEW & TUTTLE, PC, P.O. BOX 9227, SCARBOROUGH STATION, SCARBOROUGH, NY, 10510-9227, US

(21) Appl. No.: 11/027,854

(22) Filed: Dec. 30, 2004

(30) Foreign Application Priority Data
Jan. 28, 2004 (DE) 102004004146.6

(51) Int. Cl. B60P 1/64

(52) U.S. Cl. 410/77

(57) ABSTRACT

For stabilizing a stack of goods, preferably heterogeneous goods, stacked on a pallet, the invention provides a device for securing stacked articles, particularly during further stacking, which has suction devices for retaining stacked articles.

### FIELD OF THE INVENTION

The invention relates to a method and device for securing stacked articles, particularly articles of different sizes during further stacking.

### BACKGROUND OF THE INVENTION

In conjunction with the commissioning of goods, e.g. for the retail trade, as a rule mixed, heterogeneous pallets are collected. The pallets are load carriers for numerous different bundles or articles such as cartons, cardboard trays with or without shrink film, sacks or the like, which are to be stacked together on one pallet. Generally commissioning takes place in goods distribution centres and is regularly based on identical article, homogeneously stacked pallets from a number of production sites, the pallets in each case carrying identical bundles or articles. The fundamental aim is to so stabilize goods on pallets, whose stack height can be 2 m or more, in such a way that both during stacking and during conveying (transportation by handling engineering or truck) they do not tip or tilt.

In the case of homogeneously stacked products, i.e. identical article pallets, which are e.g. palletized at the end of a production line, stability is brought about in that by rotating the pallet by 180° in the individual planes projecting superstructures arise in much the same way as when bricking up a wall, so that vertical, through joints or gaps are avoided. However, even in the case of article identity, e.g. with bundle dimensions having a square plan form, stack formation in the form of “turrets” with through, lateral gaps cannot or can only be avoided with difficulty. In such cases, between the individual, horizontal pallet layers are inserted so-called slip sheets, i.e. intermediate layers, which are generally formed by paper or cardboard sheets or sheets of other materials, such as plastic foils or films.

DE 197 32 243 C2 describes a palletizing device for articles to be stacked on a pallet, such as e.g. kitchen paper rolls. The securing of the articles stacked on the pallet takes place through the insertion of slip sheet papers. However, such a securing of the articles on the one hand only offers limited stability and also such securing by means of slip sheets only functions in the case of articles having the same dimensions or when articles have different sizes stack formation must take place in such a way that the top sides of the stacked articles to which the slip sheet is to be applied are roughly at the same height.

DE 43 28 155 A1 discloses a device for handling, particularly for stacking and destacking closely engaging, flat articles with a smooth surface, such as glass plates. The device comprises a suction gripper having suction heads, which grips in sucking manner the glass plates by vacuum thereon and places the same on a stack. There is no securing of the semifinished or finished stack, particularly during further stacking.

In the case of commissioning in the sense of stacking heterogeneous goods or articles with different dimensions, due to the vast number of different bundle heights it is extremely difficult to bring about an inherent stack stability, i.e. a stack stability as such without additional securing measures, by means of projecting superstructures or the insertion of slip sheets.

If commissioning takes place in a goods distribution centre on a target pallet (target load carrier), as a result of his experience the stacking person can create a relatively stable stack with a maximum number of projecting superstructures. Generally nowadays palletizing takes place in a chaotic manner, i.e. a commissioner generally proceeds in accordance with an order list or a predetermined order sequence and stacks the articles in accordance with the list generally without any knowledge of the further articles to be commissioned. So as to stabilize pallets to some extent in spite of this, a commissioner preferably starts with large bundles in the corners of the basic pallet dimensions and subsequently fills these with articles in such a way that a minimum number of gaps arises. Only then is the central area of the basic pallet dimensions filled with bundles. This procedure leads to a significant stability and in the case of instability to the mixed pallet load colliding towards the pallet centre and not away from the pallet. However, on reaching a corresponding stack height of e.g. 1.4 to 1.6 m, such mixed pallets become very unstable. In order to prevent the tipping of such pallets during manual commissioning, as from a given stack height stretch film is drawn around the already stacked height to secure the pallet and then further commissioning takes place thereon.

DE 40 26 449 C2 describes a device for the automatic palletizing of articles of different sizes, the device detecting the individual shape of the articles by means of a detection system and stacks the same as compactly as possible without additional securing measures.

With mixed, automatic palletizing by means of mechanical systems, such as robots, gripping systems, handling engineering, using palletizing algorithms, the interim securing of the pallet with stretch film is a critical solution from the process engineering standpoint, because as a result individual bundles as a result of film tensioning during securing undergo a change in their position or orientation on the pallet. The change is critical, because it takes place in an undefined manner and therefore with high probability can lead to subsequent collisions.

Therefore the problem of the invention is to so further develop a method and device for securing stacked articles of the aforementioned type that, whilst avoiding the aforementioned disadvantages, it is possible to bring about a secure, inexpensive stacking of articles with different sizes and up to a desired stack height in a stable manner.

### SUMMARY OF THE INVENTION

In the case of a device of the aforementioned type, the invention solves this problem in that suction devices are provided for retaining stacked articles, the suction devices being positioned on suction strips and are constructed in such a way that they are able to secure the stacked articles during further stacking.

In the case of a method for securing stacked articles of the aforementioned type, the invention solves the set problem in that stacked articles are retained during further stacking in a predetermined position by means of vacuum by suction on a suction strip having suction devices.

In a preferred embodiment the suction devices are individually or zonally activatable, the suction devices being in particular possible to have passive valves, so that in a suction device a vacuum is only applied if the suction device engages with an article. The suction devices can e.g. be formed by suction cups provided with valves.

The suction devices located on the suction strips are in a preferred development connected to a suction frame. The connection between the suction strips and suction frame is preferably movable and is such that the suction devices are connected by means of cylinders to the suction frame.

The suction frame can be in one or at least two pieces. In the latter case suction frame parts can either be movable against one another, particularly horizontally, or can be folded against one another from a preferably vertical position into a horizontal orientation. The suction frame is preferably held on struts or posts.

As a result of the inventive development of the device for securing stacked articles, it is possible that the outer articles of a bundle are held by means of the suction device in a precise position at a predetermined, optionally variable stack height. Due to the fact that the suction devices act from the outside on the articles, the latter cannot tilt outwards. As a result of the suction process the articles are prevented from collapsing towards the interior of the pallet, being reliably held and stabilized.

Preferably the action of the suction device takes place at a height which is still stable without any securing measures, e.g. at a height of 1.4 to 1.6 m. If the stack is stabilized in accordance with the invention, the remaining stack height (up to 2 or more metres) can subsequently be placed without any problem on the inventively stabilized stack height, without there being any pallet instability or without fearing a collision. The retaining forces which are to be applied by the suction action are relatively small. The suction elements can therefore be designed inexpensively.

Due to the fact that the suction devices are individually or zonally activatable, it is ensured that a sucking action only occurs where an article or bundle has been deposited. The sucking action only takes place when the bundle has reached the calculated stacking position.

The suction devices located on the suction strips are preferably brought by means of cylinders or other control elements into a position such that they image the basic pallet dimensions. At the end of the palletizing process and before the suction frame is removed again, for transportation securing purposes it is possible to easily and rapidly secure the pallet with stretch film, tape or the like and at this time, i.e. after ending the palletizing process, is not critical.

In order to convey the pallet away using a pallet conveyor at the end of the palletizing process, the pallet must be released from the suction frame. A one-piece frame can be removed by lowering below the pallet or raising above the stacked pallet, whilst in a preferred development on the case of a two-part frame the parts thereof are pivoted or moved away.

### BRIEF DESCRIPTION OF THE DRAWINGS

Further advantages of the invention are apparent from the following description of embodiments with reference to the attacked drawings, wherein show:

FIG. 1A perspective view of a device in use, with partly broken away portions.

FIG. 2 An embodiment of the device of FIG. 1 in plan view from above.

FIG. 3 An embodiment of the device in plan view from above.

FIG. 4 Another development of the device in side view.

### DETAILED DESCRIPTION OF THE DRAWINGS

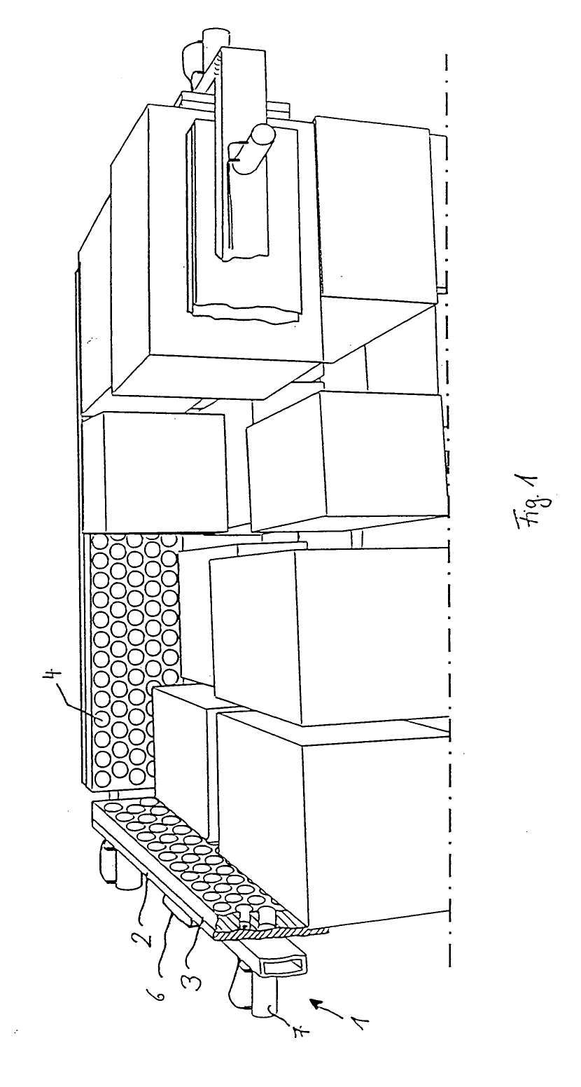

FIG. 1 shows a load on a pallet, which is not shown, the load comprising boxes or cartons of different sizes. Such a heterogeneous load collection arises if in conjunction with commissioning mixed, heterogeneous pallets are brought together in goods distribution centres. Generally the load on the mixed, heterogeneous pallet comes from identical article, homogeneously stacked pallets from numerous production sites. As a result of the different shapes and sizes the stacked load can become unstable on collecting a mixed pallet. So that there can be no falling apart or collapsing of the individually stacked goods during stacking, according to the invention a device 1 is provided for securing stacked articles using suction devices.

In the embodiment shown in FIG. 1, the device 1 has a rigid frame 2 of square pipes, which are welded together at their faces. The contour of the rigid frame 2 is somewhat above the circumferential contour of a pallet. On all four sides of the inside of the frame 2 are provided suction strips 3, which are equipped with suction devices 4 in the form of suction cups, suction mats, etc. By means of a connection 6, a vacuum can be applied to the suction devices 4 of the suction strips 3. The suction strips 3 are preferably subdivided into individual sectors, which can be individually connected in during the palletizing process and this optionally also takes place by means of passive valves, so that a sucking action only occurs where a bundle has been deposited.

In the embodiment shown, the suction strips 3 are connected to the frame 2 by means of cylinders 7, with which the suction strips 3 move against the stacked goods and can be brought into position in such a way that the suction strips image the basic pallet dimensions.

Cables 11 with electric control and supply lines 12, together with suction lines 13 passing to the cylinder 7 or suction devices 4 lead to the frame 2.

Initially the goods are stacked by a robot on the pallet in a manner determined by an optimizing algorithm and to a height where there is an adequate security against collapsing or falling apart of the goods stack on the pallet. Subsequently a device 1 is moved to the height of the highest stacked goods. The suction strips 3 are moved against the goods in position and subsequently suction air is supplied leading to a stabilization of the stack, so that further stacking can occur. Optionally a further device can be fitted in a further plane.

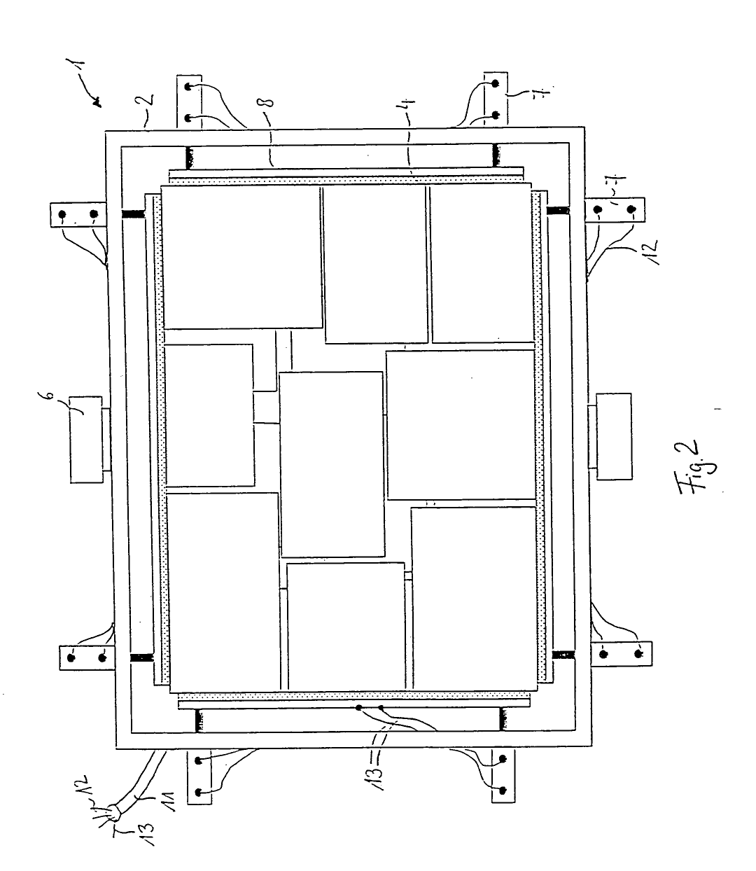

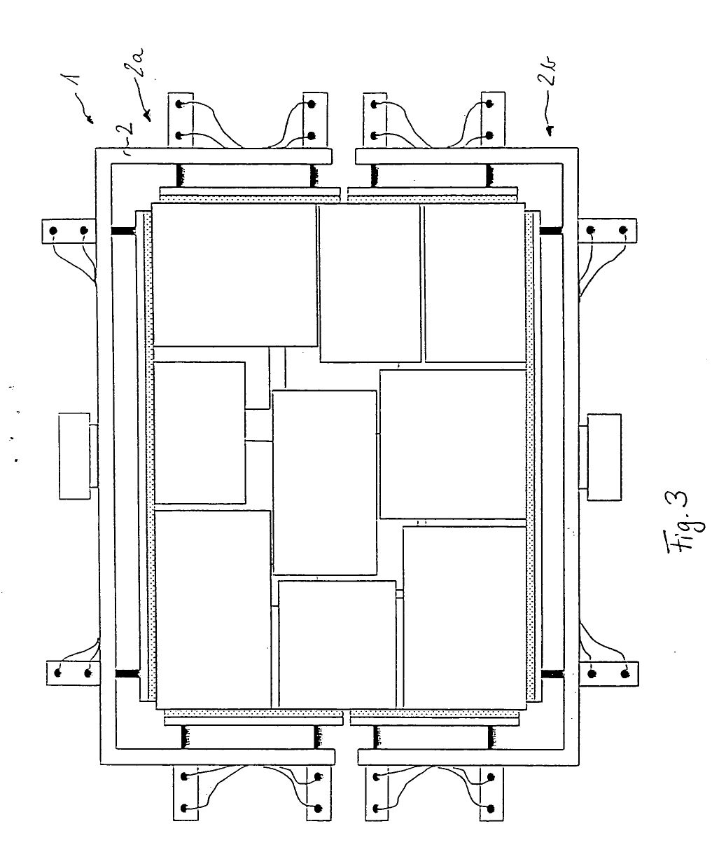

FIG. 3 shows an alternative variant of a device 1. In this case the frame 2 is in two parts 2a, 2b. Otherwise the device 1 is constructed in accordance with FIGS. 1 and 2, particularly with regards to the suction strips 3 and suction devices 4.

Unlike in the embodiment of FIGS. 1 and 2, where the device 1 must be placed around the pallet at its location, this is unnecessary in the variant of FIG. 3. Following a partial stacking process the frame parts 2a, 2b can be moved against the pallet and the goods stacked thereon from two opposing sides. Subsequently and in the already described manner the suction strips 3 are brought into position against the stacked goods without moving the same inwards. Suction pressure is then applied in the described manner for stabilizing the stack of goods.

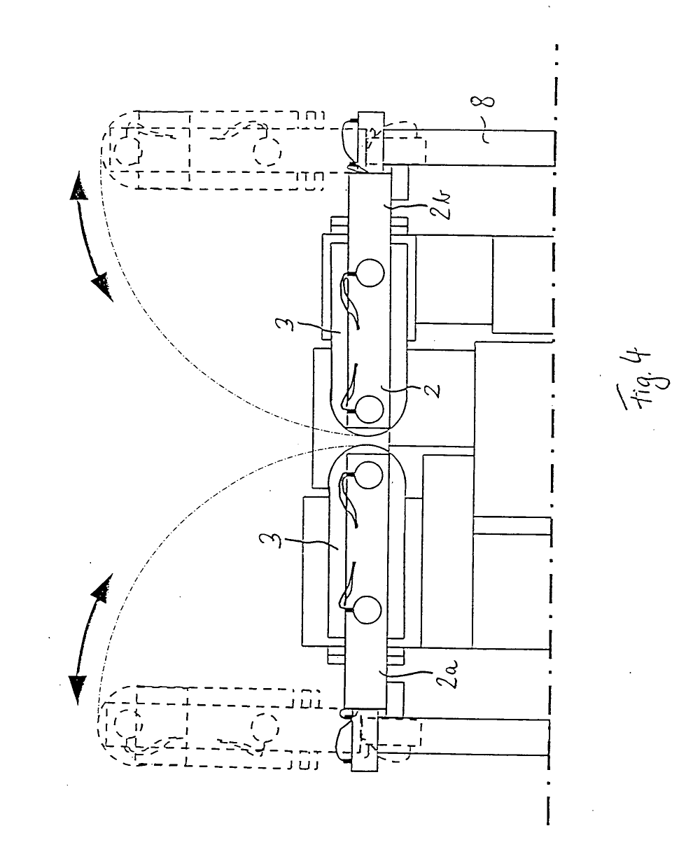

The variant of FIG. 4 also shows a two-part frame 2 with the two parts 2a, 2b. The latter are pivotably positioned on posts 8 and e.g. initially project therefrom vertically upwards. On reaching a desired stack height in which stability can be secured, the frame parts 2a, 2b are pivoted horizontally, so that their individual struts enclose the stack of goods. The bringing into position of the suction strips 3 and the suction pressure supply then occur in the already described manner.

### List of Reference Numerals

1 Device
2 Rigid frame
2a, 2b Frame part
3 Suction strips
4 Suction device
6 Connection
7 Cylinder
8 Post
11 Cable
12 Control and supply lines
13 Suction lines

1. Device for securing stacked articles, particularly those of different sizes, during further stacking, wherein suction devices are provided for holding the stacked articles, the suction devices being located on suction strips and constructed in such a way that they are able to secure the stacked articles during further stacking.

2. Device according to claim 1, wherein the suction devices are individually or zonally activatable.

3. Device according to claim 1, wherein the suction devices have passive valves, so that a vacuum is only applied in a suction device when the latter engages with an article.

4. Device according to claim 1, wherein the suction strips are connected to a suction frame.

5. Device according to claim 4, wherein the suction devices are connected by means of cylinders to the suction frame.

6. Device according to claim 4, wherein the suction frame is constructed in one piece.

7. Device according to claim 4, wherein the suction frame is constructed in at least two parts.

8. Device according to claim 7, wherein the frame parts are movable against one another on a pallet of stacked goods.

9. Device according to claim 7, wherein the frame parts can be pivoted into a horizontal position so as in this way to embrace goods stacked on a pallet.

10. Device according to claim 4, wherein the suction frame is held on struts or posts.

11. Method for securing stacked articles, particularly those of different sizes, during further stacking, wherein, during further stacking, the stacked articles are held in a predetermined position by a vacuum by suction on a suction strip having suction devices.

12. Method according to claim 11, wherein the stacked articles of the stack are sucked on the suction strip at a stack height in which the stack is still stable without additional securing measures.

13. Method according to claim 11, wherein the suction strips are brought into a position where they image the basic pallet dimensions.
